(19) United States
(12) Patent Application Publication
(10) Pub. No.: US 2005/0274863 A1
(43) Pub. Date: Dec. 15, 2005

(54) Fixture mounting assembly and method

(76) Inventor: Frank Blateri, Coppell, TX (US)

Correspondence Address: HAYNES AND BOONE, LLP, 901 MAIN STREET, SUITE 3100, DALLAS, TX, 75202, US

(21) Appl. No.: 10/865,280

(22) Filed: Jun. 10, 2004

(51) Int. Cl. B42F 13/00

(52) U.S. Cl. 248/343; 248/342

(57) ABSTRACT

A fixture mounting assembly and method according to which a coupling member is attached to the fixture, and a downrod is pivotally mounted to the coupling member and is mounted to the ceiling.

### BACKGROUND

The present invention relates to an assembly and method for mounting a fixture, such as a ceiling fan or light, in a spaced relation to a ceiling.

Various ceiling-mountable fixtures, such as fans, lights (semiflushes, chandeliers, pedants, etc,), loudspeakers, monitors, video cameras, televisions, and the like, are usually connected to an electrical box, terminal, or the like, at the ceiling. When it is desired to mount the fixture in a spaced relation to the ceiling, a downrod is often connected between the electrical box, or terminal, and the fixture. Normally an installer has to attach the downrod to the fixture, fish electrical conductors from the fixture through the downrod, and attach the downrod to the ceiling. This is labor intensive and adds to the cost of the fixture.

Therefore what is needed is an installation assembly and method that facilitates the above installation and reduces the installation time.

### BRIEF DESCRIPTION OF THE DRAWINGS

FIGS. 1-3 are enlarged isometric views of an assembly according to an embodiment of the invention, depicted in different operational modes.

### DESCRIPTION OF THE PREFERRED EMBODIMENT

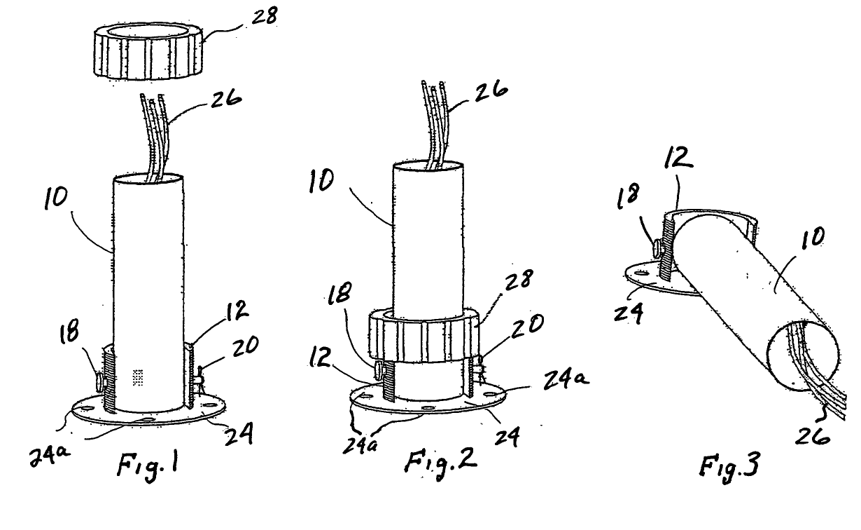

Referring to FIG. 1 of the drawings, the reference 10 refers, in general, to a downrod that is designed to connect a fixture (not shown), such as a ceiling fan, light, or the like, in a spaced relation to a ceiling. To this end, the upper end portion of the downrod 10, as viewed in FIG. 1, would be connected to a conventional electrical box terminal, or the like, (not shown), mounted in the ceiling.

The lower end portion of the downrod 10 is pivotally mounted to an externally threaded coupling member 12 having a semi-annular cross section. To effect this pivotal movement, a pivot bolt 18 extends through aligned openings formed through the coupling member 12 and the downrod 10, and a locking pin 20 is attached to an end portion of the bolt. The diameters of the above openings are larger than the diameter of the bolt 18 to permit pivotal movement of the downrod 10 relative to the coupling member between a substantially vertical position shown in FIGS. 1 and 2 to a substantially horizontal position shown in FIG. 3.

The lower end of the coupling member 12 is attached, in any conventional manner, to a mounting plate 24 having a series of angularly-spaced openings 24a formed through the plate. The mounting plate 24 is adapted for attachment to a fixture (not shown) that is to be mounted, in a spaced relation, to the ceiling. For example, if the fixture were a ceiling fan, the mounting plate could be attached to the motor housing of the fan by inserting screws, bolts, or the like (not shown) through the openings 12a and into corresponding openings in the housing, in a conventional manner.

A plurality (three in the example shown in the drawings) of electrical conductors 26 extend from the above-mentioned fixture, through a central opening (not shown) in the plate 24, and up through the interior of the downrod 10, with the free end portions of the electrical conductors extending out a few inches from the upper end of the downrod as shown in FIGS. 1 and 2. It is understood that the electrical conductors 26 can be connected to appropriate terminals or electrical conductors provided in the electrical box in the ceiling that extend from an electrical power source so that the fixture is electrically powered.

As shown in FIG. 2, an internally threaded nut 28 is provided that is adapted to threadedly engage the upper portion of the externally threaded coupling member 12 to secure the downrod 10 in the vertical position shown in FIGS. 1 and 2. In this position, when the upper end portion of the downrod 10 is connected to the ceiling in the manner discussed above, and the mounting plate 24 is connected to the fixture, the fixture is mounted in a spaced relation to the ceiling.

In order to enable the assembly shown in FIGS. 2 and 3 to be easily packed and shipped, the nut 28 can be removed (and packed separately) and the downrod 10 pivoted to a substantially horizontal position shown in FIG. 3. (The pin 20 could be removed from the bolt 18 and the bolt removed from the coupling 12 and the downrod 10 removed from the coupling 12, if necessary).

To mount the fixture to the ceiling, the downrod 10 is simply pivoted to its substantially vertical position shown in FIGS. 1 and 2, and the nut 28 is then threadedly engaged over the coupling 12. The electrical conductors 26 from the fixture can then be threaded through the mounting plate 24 and the downrod 10 and connected to the above-mentioned terminals or conductors in the ceiling. The downrod 10 then can be connected to the ceiling. Alternatively, the electrical conductors 26 from the electrical box, terminal, or the like at the ceiling can be threaded through the downrod 10 and the mounting plate 24, and connected to terminals or conductors in the fixture, after which the downrod 10 is connected to the ceiling.

The assembly of the present invention thus enables the fixture 10 to be easily and quickly mounted to the ceiling while taking up relatively little extra space when packing and shipping.

It is understood that variations may be made in the foregoing without departing from the scope of the invention. For example, the mounting plate 24 can be connected to the fixture in any conventional manner other than that disclosed above, or it can be formed integrally with the fixture. Also, the mounting plate 24 can be eliminated and the coupling member can be connected directly to the fixture. Further, the shape of the coupling member 12 and the mounting plate 24 can be varied. Moreover, the manner of pivotally connecting the downrod 10 to the coupling member 12 can be varied. Still further, the spatial references, such as “upper”, “lower”, “downwardly”, etc., are for the purpose of illustration only and do not limit the spatial orientation or location of the structure described.

It is understood that other modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

1. An assembly for mounting a fixture to a ceiling, the assembly comprising a coupling member attached to the fixture, and a downrod pivotally mounted to the coupling member and adapted to be connected to the ceiling.

2. The assembly of claim 1 wherein the downrod normally extends substantially vertically for connection to the ceiling and is pivotal to a substantially horizontal position.

3. The assembly of claim 2 further comprising a retaining member for extending around the downrod and engaging the coupling member to retain the downrod substantially vertically.

4. The assembly of claim 3 wherein the coupling member is externally threaded and the retaining member is an internally threaded nut that threadedly engages the coupling member.

5. The assembly of claim 1 further comprising a mounting plate on the fixture, the coupling member being connected to the mounting plate.

6. The assembly of claim 5 wherein the mounting plate is adapted to be connected to the fixture

7. The assembly of claim 5 wherein the mounting plate is formed integrally with the fixture

8. The assembly of claim 1 wherein the coupling member has a semi-annular cross section to permit the pivotal movement.

9. The assembly of claim 1 further comprising a bolt extending through aligned openings in the downrod and the coupling member to pivotally mount the downrod to the coupling member.

10. A method of mounting a fixture to a ceiling, the method comprising connecting a coupling member to the fixture, pivotally mounting a downrod to the coupling member, and connecting the downrod to the ceiling.

11. The method of claim 10 further comprising extending the downrod substantially vertically for connection to the ceiling, and pivoting the downrod to a substantially horizontal position for packing and/or shipping.

12. The method of claim 11 further comprising engaging the coupling member with a retaining member that extends around the downrod to retain the downrod substantially vertically.

13. The method of claim 12 further wherein the coupling member is threadedly engaged with the retaining member.

14. The method of claim 10 wherein the first-mentioned step of connecting comprises connecting the coupling member to a mounting plate on the fixture.

15. The method of claim 14 further comprising connecting the mounting plate to the fixture.

16. The method of claim 14 further comprising forming the mounting plate integrally with the fixture.

17. The method of claim 10 further comprising forming the coupling member with a semi-annular cross section to permit the pivotal movement.

18. The method of claim 10 wherein the step of pivotally mounting comprises inserting a bolt through aligned openings in the downrod and the coupling member.
